(19) United States
(12) Patent Application Publication
(10) Pub. No.: US 2017/0079116 A1
(43) Pub. Date: Mar. 16, 2017

(54) TWO-LEVEL DETECTION LIGHTING FIXTURE

(71) Applicant: Test Rite International Company, LTD., Taipei City (TW)

(72) Inventor: Edward KAO, Taipei City (TW)

(21) Appl. No.: 15/219,314

(22) Filed: Jul. 26, 2016

(30) Foreign Application Priority Data
Sep. 10, 2015 (CN) 201520697420.X

(51) Int. Cl. H05B 37/02

(52) U.S. Cl. CPC H05B 37/0218; H05B 37/0227

(57) ABSTRACT

The present invention provides a two-level detection lighting fixture, comprising: a lighting module, comprising a primary lamp and a secondary lamp; a detection module, comprising an environment detector for detecting an ambient light level and generating a first signal, and a human motion detector for detecting human motion within a predetermined area surrounding the lighting module and generating a second signal; and a control module for controlling the secondary lamp of the lighting module to turn on or off, receiving the first signal and the second signal generated by the detection module, and driving the primary lamp of the lighting module to turn on by using the first signal or the second signal. Conventional motion sensing lights have a common drawback that a light is only turned on when a person passes through the surrounding area of the light. The present invention overcomes this drawback and thereby provides lighting with improved security.

### BACKGROUND OF THE INVENTION

1. Field of the Invention

The present invention relates to a lighting fixture, and more particularly, to a two-level detection lighting fixture which detects both ambient light levels and human motion.

2. Description of the Prior Art

As people are paying more attention to environmental and energy efficiency issues nowadays, various lighting fixtures with energy-saving features have been developed to meet the needs of customers. For example, motion sensing lights are commonly used to illuminate a staircase, doorway or basement of a building, since these locations do not expect many passers-by at all times—when a person approaches, the light is automatically turned on, and when no one is nearby, the light is turned off to save energy. Motion sensing lights are also commonly used to illuminate streets or corridors with fewer passersby in order to save energy; they can also be used to illuminate balconies to deter burglars. Motion sensing lights are therefore commonly used for energy-saving and security purposes. However, as far as the above lighting applications are concerned, the motion sensing lights are not turned on until someone approaches. And since lighting fixtures are consumables, if no one passes by for a certain period of time to make the lights activated, the lighting fixtures may start to malfunction, or may be completely out of order without being noticed and properly repaired. Such malfunctions can cause security problems. In view of the above, there exists a need in the industry to develop a sensor-based lighting fixture that can provide lighting with improved security.

This need could be addressed by exploring the use of a two-level detection lighting fixture comprising a primary lamp and a secondary lamp. When no one is nearby, the secondary lamp continues to provide lighting at a low light level with low electricity consumption; and when human motion is detected, the primary lamp can be controlled to turn on to provide lighting.

### SUMMARY OF THE INVENTION

An object of the present invention is to provide a two-level detection lighting fixture, which is capable of detecting an ambient light level and human motion so as to, based on the detection results, turn on a primary lamp of the lighting fixture for a predetermined duration, and then to turn off the primary lamp while keeping a secondary lamp lit.

To achieve the foregoing object, a two-level detection lighting fixture according to the present invention comprises: a lighting module, comprising a primary lamp and a secondary lamp; a detection module, comprising an environment detector for detecting an ambient light level and generating a first signal, and a human motion detector for detecting human motion within a predetermined area surrounding the lighting module and generating a second signal; and a control module for controlling the secondary lamp of the lighting module to turn on or off, receiving the first signal and the second signal generated by the detection module, and driving the primary lamp of the lighting module to turn on by using the first signal or the second signal.

The two-level detection lighting fixture according to the present invention further comprises a delay module for setting duration for which the primary lamp remains lit.

Preferably, the detection module is positioned under the lighting module.

Preferably, a rear part of the detection module is provided with a duration setting button, a light level setting button and a distance setting button.

Preferably, the duration setting button is used for setting duration of time for which the primary lamp remains lit after the detection module has detected human motion signals and the primary lamp has been turned on.

Preferably, the light level setting button is used for setting an ambient light level to turn on the secondary lamp when the detection module detects that the ambient light level is reached.

Preferably, the distance setting button is used for setting a distance between an approaching person and the lighting fixture at which the detection module starts detecting human motion signals.

Conventional motion sensing lights have a common drawback that a light is only turned on when a person passes through the surrounding area of the light. The present invention overcomes this drawback and provides lighting with improved security.

### BRIEF DESCRIPTION OF THE DRAWINGS

FIG. 1 is a block diagram schematically showing a two-level detection lighting fixture according to the present invention.

FIG. 2 is a schematic view showing the appearance and construction of the two-level detection lighting fixture according to the present invention.

FIG. 3 is a schematic view showing a detection module of the two-level detection lighting fixture according to the present invention.

### DETAILED DESCRIPTION OF THE PREFERRED EMBODIMENTS

These and other features, aspects, and advantages of the present invention will be described in more detail below with reference to the accompanying drawings, in which preferred embodiments of the present invention are illustrated.

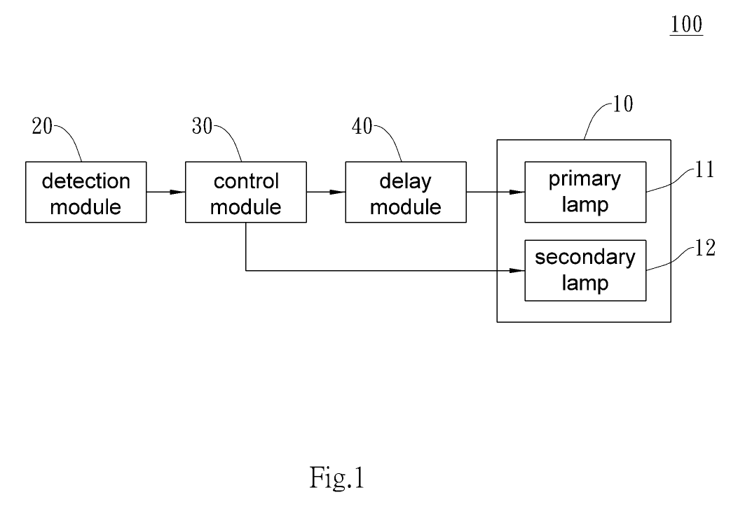

FIG. 1 is a block diagram schematically showing a two-level detection lighting fixture according to the present invention. As shown in FIG. 1, a two-level detection lighting fixture 100 comprises: a lighting module 10 comprising a primary lamp 11 and a secondary lamp 12; a detection module 20 comprising an environment detector and a human motion detector, the environment detector detecting an ambient light level and generating a first signal, the human motion detector detecting human motion within a predetermined area surrounding the lighting module and generating a second signal; and a control module 30 for controlling the secondary lamp 12 of the lighting module 10 to turn on or off, receiving the first signal and the second signal generated by the detection module 20, and driving the primary lamp 11 of the lighting module 10 to turn on by using the first signal or the second signal.

As FIG. 1 shows, the two-level detection lighting fixture 100 according to the present invention further comprises a delay module 40. The delay module 40 is used for setting the duration for which the primary lamp 11 remains lit. Thus, when the environment detector of the detection module 20 detects a change of the ambient light to a certain extent or the human motion detector of the same module detects that there is human motion, the control module 30 will be driven to turn on the primary lamp 11 and make it continue to provide lighting for a predetermined period of time; the primary lamp 11 is not turned off until the predetermined period of time has elapsed.

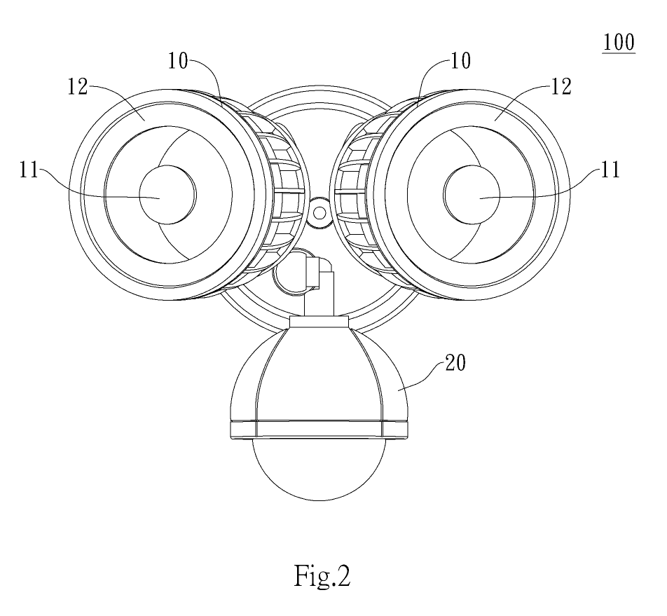

FIG. 2 is a schematic view showing the appearance and construction of the two-level detection lighting fixture according to the present invention. In the embodiment shown in FIG. 2, the two-level detection lighting fixture 100 has a pair of lighting modules 10 arranged symmetrically at the left and right sides of the lighting fixture 100. The detection module 20 is positioned under the center of the pair of lighting modules 10. The two-level detection lighting fixture 100 can be installed at places where lighting is required, such as staircases, doorways, basements or eaves.

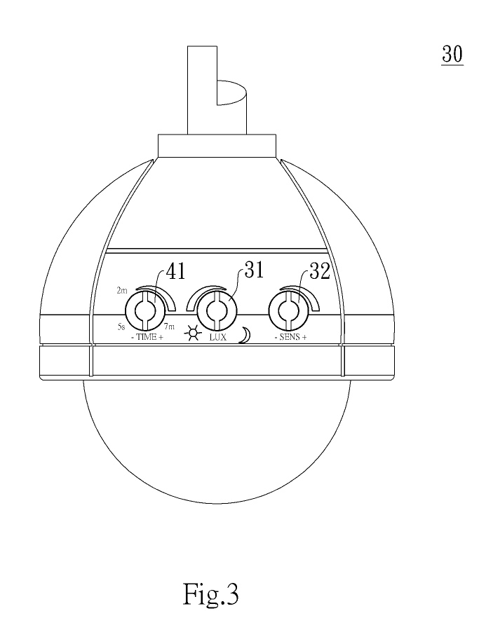

FIG. 3 is a schematic view showing a detection module of the two-level detection lighting fixture according to the present invention. The rear part of the detection module 20 of the two-level detection lighting fixture 100 is provided with a duration setting button 41, a light level setting button 31, and a distance setting button 32. The duration setting button 41 is used for setting the desired duration of time for which the primary lamp 11 remains lit after the detection module 20 has detected human motion signals and the primary lamp 11 has been turned on. The light level setting button 31 is used for setting a desired ambient light level to turn on the secondary lamp 12 when the detection module 20 detects that the set ambient light level is reached. The distance setting button 32 is used for setting a distance between an approaching person and the lighting fixture at which the detection module 20 starts detecting human motion signals.

When using the two-level detection lighting fixture 100, the user may first adjust the duration setting button 41, the light level setting button 31, and the distance setting button 32 to the desired settings. Then, the environment detector of the detection module 20 starts detecting ambient light levels and the human motion detector of the same module starts detecting if there is human motion within a preset range surrounding the lighting module 10. If the environment detector or the human motion detector of the detection module 20 does not detect any change in the environment, then the control module 30 controls the secondary lamp 12 to provide lighting at a low light level. On the contrary, if the environment detector of the detection module 20 detects a change in the ambient light level to a certain extent, or the human motion detector of the detection module 20 detects human motion, the first signal or the second signal is then sent to the control module 30. The control module 30 then controls the primary lamp 11 to start providing lighting for a period of time in accordance with the duration set for the delay module 40. When the preset period of time has elapsed, the primary lamp 11 is turned off, but the secondary lamp 12 continues to provide lighting at a low light level.

If the two-level detection lighting fixture 100 according to this embodiment is applied in a garden environment and the environment detector or the human motion detector of the detection module 20 does not detect any change in the environment, the control module 30 will then control the secondary lamp 12 to provide lighting at a low light level. In this way, the lighting modules 10 (see FIG. 2) look like a pair of eyes watching the garden while illuminating it. Therefore, the two-level detection lighting fixture 100 according to the present invention can provide continuous lighting at a low light level, and can also act as a deterrent to intruders.

To sum up, the two-level detection lighting fixture according to the present invention uses the detector module to detect ambient light levels and human motion, and can thereby turn on the primary lamp to provide lighting for a predetermined duration; when the predetermined period of time has elapsed, the primary lamp is turned off and the secondary lamp continues to provide lighting. If the environment detector or the human motion detector of the detection module does not detect any change in the environment, then the control module controls the secondary lamp to provide lighting at a low light level. Conventional motion sensing lights have a common drawback that a light is only turned on when a person passes through the surrounding area of the light. The present invention overcomes this drawback and provides lighting with improved security.

What is claimed is:

1. A two-level detection lighting fixture, comprising:
a lighting module, comprising a primary lamp and a secondary lamp;
a detection module, comprising an environment detector for detecting an ambient light level and generating a first signal, and a human motion detector for detecting human motion within a predetermined area surrounding the lighting module and generating a second signal; and
a control module for controlling the secondary lamp of the lighting module to turn on or off, receiving the first signal and the second signal generated by the detection module, and driving the primary lamp of the lighting module to turn on by using the first signal or the second signal.

2. The two-level detection lighting fixture of claim 1, further comprising a delay module for setting duration for which the primary lamp remains lit.

3. The two-level detection lighting fixture of claim 1, wherein the detection module is positioned under the lighting module.

4. The two-level detection lighting fixture of claim 2, wherein the detection module is positioned under the lighting module.

5. The two-level detection lighting fixture of claim 3, wherein a rear part of the detection module is provided with a duration setting button, a light level setting button and a distance setting button.

6. The two-level detection lighting fixture of claim 5, wherein the duration setting button is used for setting duration of time for which the primary lamp remains lit after the detection module has detected human motion signals and the primary lamp has been turned on.

7. The two-level detection lighting fixture of claim 5, wherein the light level setting button is used for setting an ambient light level to turn on the secondary lamp when the detection module detects that the ambient light level is reached.

8. The two-level detection lighting fixture of claim 5, wherein the distance setting button is used for setting a distance between an approaching person and the lighting fixture at which the detection module starts detecting human motion signals.
